(19) United States
(12) Patent Application Publication
(10) Pub. No.: US 2010/0212025 A1
(43) Pub. Date: Aug. 19, 2010

(54) INFORMATION PROCESSING APPARATUS, AND CONTROL METHOD AND STORAGE MEDIUM THEREOF

(75) Inventor: Takeshi Suwabe, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/690,473

(22) Filed: Jan. 20, 2010

(30) Foreign Application Priority Data
Feb. 18, 2009 (JP) 2009-035810

(51) Int. Cl. H04L 9/32; G06F 21/00

(52) U.S. Cl. 726/28

(57) ABSTRACT

An information processing system, an information processing apparatus, and a control method thereof are provided that, without requiring a server for holding user information, effectively utilize the memory resources of each apparatus connected via a network to perform screen display and processing for each user. To accomplish this, the information processing system is provided with a plurality of information processing apparatuses provided with a storage area that stores personalized data, which is information unique to each user. When a portable authentication device is connected, each information processing apparatus reads out device information that indicates which information processing apparatus is storing the user information and the personalized data, performs authentication, and acquires the corresponding personalized data based on the device information. The personalized data is stored in the storage area at the time when access is performed by the user.

### BACKGROUND OF THE INVENTION

1. Field of the Invention

The present invention relates to an information processing apparatus that performs processing that has been personalized for each user in each of apparatuses that have been connected via a network, and a method and a computer-readable storage medium for controlling the information processing apparatus.

2. Description of the Related Art

Personalizing technology is known whereby screen display and processing is performed for each user in a system in which an information processing apparatus capable of user authentication such as an image forming apparatus, a PC, or a server has been connected via a network. For example, in Japanese Patent Laid-Open No. 11-17862, technology is disclosed whereby a personalized server or PC is disposed as a storage location for personalized data, position information of the server/PC is determined from a network address included in an ID card used for user authentication, and personalized data is acquired.

However, with the above conventional technology, a personalized server or PC that stores personalized data is separately necessary.

### SUMMARY OF THE INVENTION

The present invention enables realization of an information processing apparatus that performs personalized processing in each apparatus connected via a network without using a server for holding user information, and a method and a computer-readable storage medium for controlling the information processing apparatus.

One aspect of the present invention provides an information processing apparatus that is provided with a storage unit that stores personalized data, which is unique setting information for each user regarding processing executed by the information processing apparatus, and is connected to another information processing apparatus via a network, the information processing apparatus comprising: a read-out unit that reads out, when a portable authentication device that stores user information for authenticating a user and device information has been connected, the user information and the device information, the device information indicating which information processing apparatus among a plurality of information processing apparatuses connected via the network is storing the personalized data corresponding to the user; an authentication unit that performs processing related to authentication of the user by use of the user information; an acquisition unit that, when authentication by the processing related to authentication of the user by the authentication unit has been successful, acquires the personalized data from the other information processing apparatus via the network in a case where the device information indicates the other information processing apparatus, and acquires the corresponding personalized data from the storage unit in a case where the device information indicates the information processing apparatus; and an execution unit that executes user-unique processing based on the acquired personalized data.

Another aspect of the present invention provides a method for controlling an information processing apparatus that is provided with a storage unit that stores personalized data, which is unique setting information for each user regarding processing executed by the information processing apparatus, and is connected to another information processing apparatus via a network, the method comprising: reading out, when a portable authentication device that stores user information for authenticating a user and device information has been connected, the user information and the device information, the device information indicating which information processing apparatus among a plurality of information processing apparatuses connected via the network is storing the personalized data corresponding to the user; performing processing related to authentication of the user by use of the user information; acquiring, when the authentication has been successful, the personalized data from the other information processing apparatus via the network in a case where the device information indicates the other information processing apparatus, and acquiring the corresponding personalized data from the storage unit in a case where the device information indicates the information processing apparatus; and executing user-unique processing based on the acquired personalized data.

Still another aspect of the present invention provides a computer-readable storage medium storing a computer program that causes a computer to execute the control method.

Further features of the present invention will be apparent from the following description of exemplary embodiments with reference to the attached drawings.

### BRIEF DESCRIPTION OF THE DRAWINGS

FIG. 1 shows an example of the overall configuration of an information processing system 1000 according to a first embodiment.

FIG. 2 shows an example of the configuration of an image forming apparatus according to the first embodiment.

FIG. 3 shows the data structure of a storage area 111 according to the first embodiment.

FIG. 4 shows an example of an authentication screen 400 according to the first embodiment.

FIG. 5 shows an example of a basic operation screen 500 according to the first embodiment.

FIG. 6 shows an example of a registration screen 600 according to the first embodiment.

FIG. 7 shows an example of a registration screen 700 according to the first embodiment.

FIG. 8 shows an example of a setting screen 800 according to the first embodiment.

FIG. 9 shows an example of a complete screen 900 after editing a personalized screen according to the first embodiment.

FIG. 10 shows an example of personalized data according to the first embodiment.

FIG. 11 shows an example of an acquisition request message according to the first embodiment.

FIG. 12 shows an example of a response message according to the first embodiment.

FIG. 13 is a flowchart that shows the processing procedure in an image forming apparatus 100 according to the first embodiment.

FIG. 14 is a flowchart that shows the processing procedure in an image forming apparatus 102 according to the first embodiment.

FIG. 15 shows an example of an input screen 1500 according to a second embodiment.

FIG. 16 shows an example of a selection screen 1600 according to a third embodiment.

FIG. 17 is a flowchart that shows the processing procedure in an image forming apparatus 102 according to the second embodiment.

FIG. 18 is a flowchart that shows the processing procedure in an image forming apparatus 102 according to a third embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### System Configuration

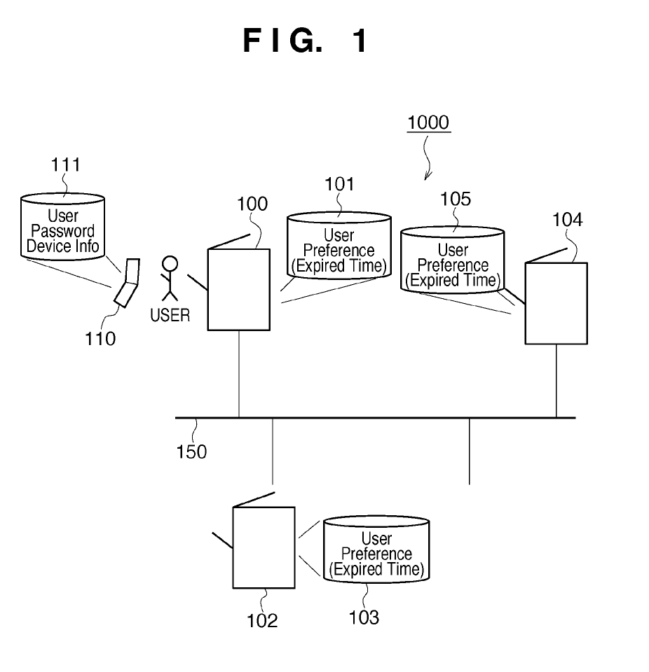

Following is a description of a first embodiment with reference to FIGS. 1 to 14. First is a description of an information processing system 1000 according to the present embodiment, with reference to FIG. 1. FIG. 1 shows an example of the overall configuration of the information processing system 1000 according to the first embodiment. Below, by way of example, an image forming apparatus is described as an example of an information processing apparatus. Examples of image forming apparatuses include various apparatuses that execute image forming, such as printers, copiers, multifunction peripherals, and facsimile apparatuses. Also, the number of devices connected to the information processing system 1000 described below is only an example, and not a limitation of the invention.

The information processing system 1000 is provided with a plurality of information processing apparatuses, for example, image forming apparatuses 100, 102, and 104. The apparatuses are connected via a LAN (local area network) 150. The image forming apparatuses 100, 102, and 104 respectively have storage areas 101, 103, and 105 where unique personalized data is saved for each user. Reference numeral 110 denotes a portable authentication device, and for example, is a portable telephone, an IC card, or the like. The portable authentication device 110 has a storage area 111 where user information and device information that specifies an apparatus that holds personalized data are saved.

A user performs user authentication using the portable authentication device 110, and registers a personalized screen in the image forming apparatus 100. A personalized screen is a user-unique display screen displayed in an image forming apparatus. At the same time as registering a personalized screen, a term of validity is set, and that data also is saved. According to the present embodiment, when a personalized screen is registered, device information (such as an IP address and host name) of the image forming apparatus in which that personalized screen was registered, that is, in this case device information of the image forming apparatus 100, is written to the portable authentication device 110.

After the user has registered a personalized screen in the image forming apparatus 100, when operating the image forming apparatus 102 using the portable authentication device 110, first, the user performs user authentication for the image forming apparatus 102 using the portable authentication device 110. As a result, the image forming apparatus 102 specifies the location where the personalized data is held (here, the image forming apparatus 100) based on the device information saved in the portable authentication device 110. Further, the image forming apparatus 102 acquires the personalized data from the image forming apparatus 100 specified by the device information. The acquired personalized data (including the term of validity) is stored in the storage area 103, where personalized data of the image forming apparatus 102 is stored. Further, the image forming apparatus 102 updates the device information saved in the portable authentication device 110 with new device information. Specifically, the device information (such as IP address and host name) of the image forming apparatus 102 is written to the portable authentication device 110.

Configuration of Image Forming Apparatus

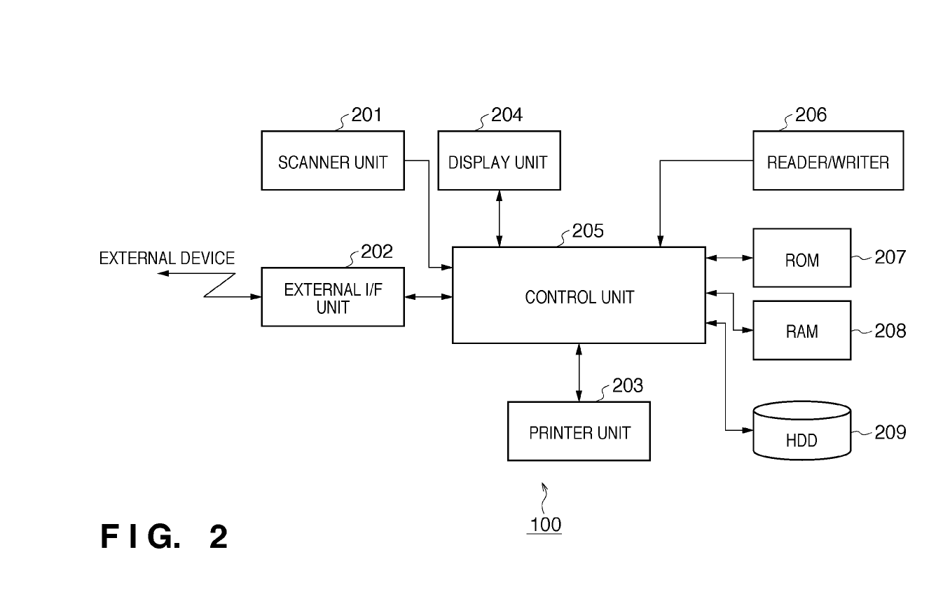

Next is a description of the configuration of the image forming apparatus according to the present embodiment, with reference to FIG. 2. FIG. 2 shows an example of the configuration of the image forming apparatus according to the first embodiment. Here, an example configuration of the image forming apparatus 100 is described, but the image forming apparatuses 102 and 104 have a similar configuration.

As shown in FIG. 2, the image forming apparatus 100 is provided with a scanner unit 201, an external I/F unit 202, a printer unit 203, a display unit 204, a control unit 205, a reader/writer 206, a ROM 207, a RAM 208, and an HDD 209. The printer unit 203 forms an image on a recording material according to job data received from the scanner unit 201 or job data received via the external I/F unit 202. The external I/F unit 202 performs communications with an external apparatus connected via the LAN 150. The display unit 204, for example, is a touch panel-type LCD panel, and includes an operation unit that serves as a user interface.

The reader/writer 206 is capable of connection to the portable authentication device 110, and executes write processing and read out processing to/from the portable authentication device 110. Specifically, when that portable authentication device is connected, the reader/writer 206 reads out user information and device information described below, and the like. Also, with the portable authentication device 110 in a connected state, the reader/writer 206 updates the information stored in the portable authentication device 110. Here, connection includes both a physical connection using a cable or the like, and connection in a non-contact state by wireless communications or the like.

The control unit 205 performs central control of processing, operation and so forth of the various units provided in the image forming apparatus 100. A control program for executing various processing and so forth described later is stored in the ROM 207, which is a read-only memory. Also, a display control program for causing the display unit 204 to display various display screens is stored in the ROM 207. By reading out and executing the programs of the ROM 207, the control unit 205 causes the image forming apparatus 100 to execute various operations. The RAM 208 is a memory for which read out and writing are possible, and stores image data forwarded from the scanner unit 201 or the external I/F unit 202, various programs, and setting information. Data of a plurality of jobs to be processed is stored in the HDD 209. Personalized data is stored in the RAM 208 or the HDD 209.

Portable Authentication Device

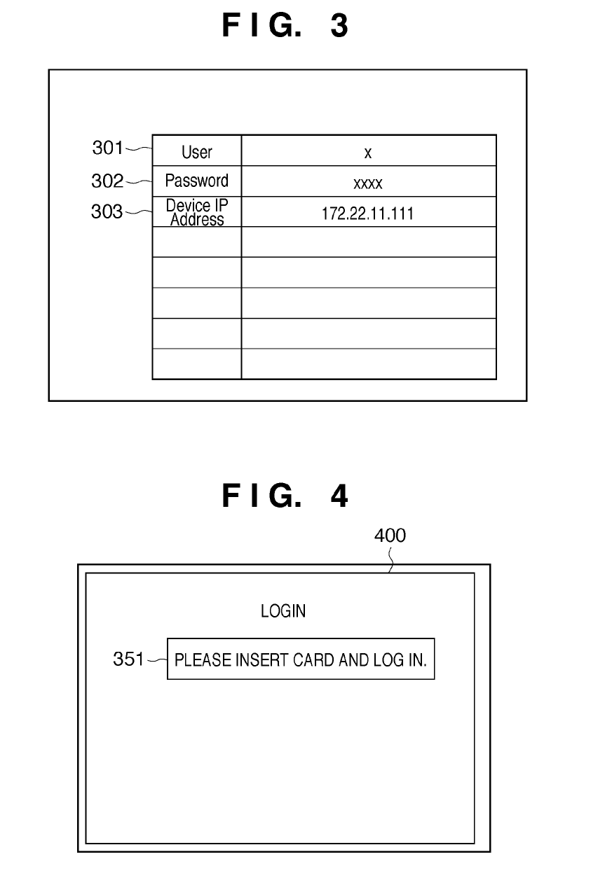

Next is a description of information stored in the storage area 111 of the portable authentication device 110, with reference to FIG. 3. FIG. 3 shows the data structure of the storage area 111 according to the first embodiment.

The storage area 111 includes fields 301, 302, and 303, for example. A username is stored in the field 301. A password uniquely assigned to each user is stored in the field 302. Device information is stored in the field 303. The username and password are data that is statically set when using the portable authentication device 110. On the other hand, the device information stored in the field 303 is rewritten each time that the user accesses an image forming apparatus.

Various Display Screens

Next is a description of an authentication screen displayed in the display unit 204 of an image forming apparatus, with reference to FIG. 4. FIG. 4 shows an example of an authentication screen 400 displayed in the display unit 204 of the image forming apparatus according to the first embodiment. The authentication screen 400 described here is an example of a screen displayed when dealing with the portable authentication device 110, as an authentication medium.

The authentication screen 400, for example, includes a display that prompts insertion of an IC card, as indicated by reference numeral 351. According to this screen, the user inserts the portable authentication device 110 at a predetermined location in the image forming apparatus, and authentication is performed.

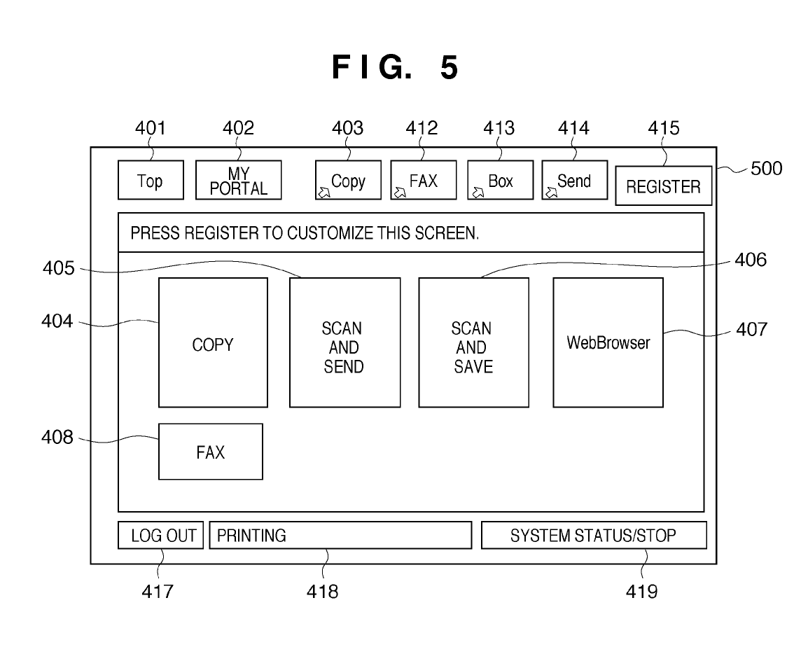

Next is a description of a basic operation screen displayed in the display unit 204 of the image forming apparatus after authentication is successful, with reference to FIG. 5. FIG. 5 shows an example of a basic operation screen 500 displayed in the display unit 204 of the image forming apparatus according to the first embodiment. The display unit 204 of the image forming apparatus, for example, is a touch panel-type LCD panel, and functions as an operation unit. Accordingly, the user can select various settings and the like by pressing software keys displayed in the display unit 204. Hardware keys may also be provided as an operation unit.

Reference numeral 401 denotes a top menu key, and is a key prepared in order to return to a top menu screen display. Reference numeral 402 denotes a ‘my portal’ key, and when this key is pressed, for example, a screen is displayed in which only information related to a specific logged-in user is posted. Here, information related to a logged-in user is, for example, information regarding jobs that have been input by that user, or the like.

Reference numerals 404 to 408 denote various function keys, and reference numerals 403 and 412 to 414 denote shortcut keys to various functions. Reference numeral 415 denotes a registration key for performing editing of a personalized screen. When the registration key 415 is pressed, the displayed screen transitions to a registration screen 600 described later.

Reference numeral 418 denotes a status line, which is an area where, for example, information regarding a job currently being executed is displayed, or warning information regarding consumable goods (such as toner) is displayed. Reference numeral 419 denotes a system status key, which is a key for displaying a screen in which, for example, a list of jobs currently being executed and information related to a job log list can be browsed.

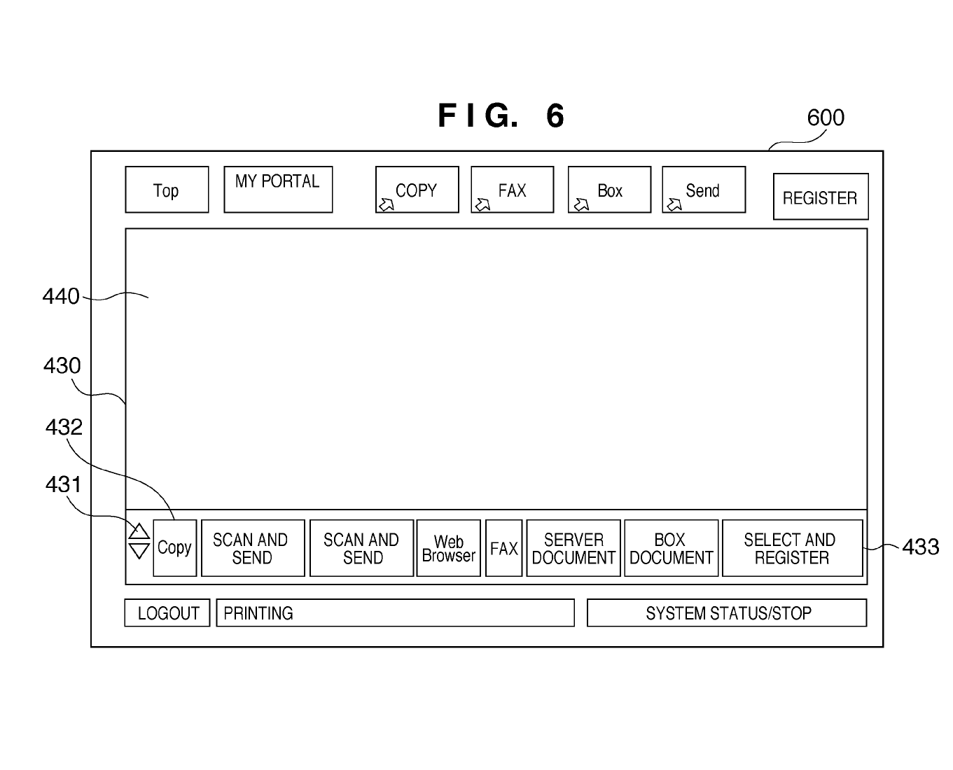

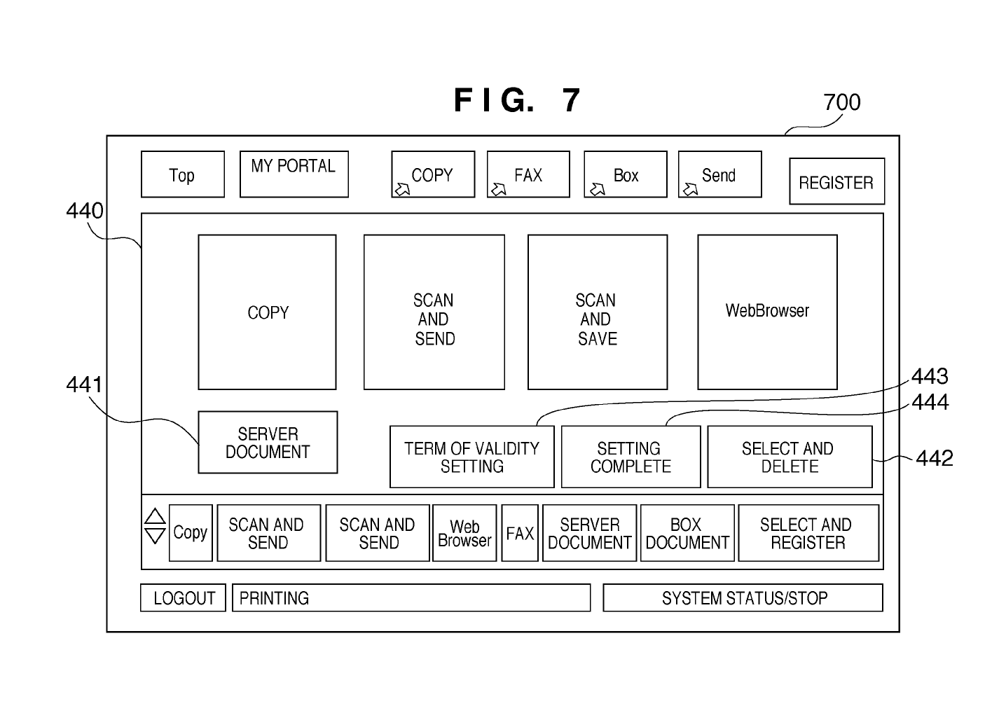

Next is a description of the registration screen displayed in the display unit 204 of the image forming apparatus when the registration key 415 in FIG. 5 has been pressed, with reference to FIG. 6. FIG. 6 shows an example of the registration screen 600 displayed in the display unit 204 of the image forming apparatus according to the first embodiment. In the registration screen 600, it is possible to edit the personalized screen.

In FIG. 6, reference numeral 430 denotes a field where display components are displayed, and that includes a copy display component 432 and so forth, for example. Also, a scroll key 431 is displayed in the field 430, and is used by scrolling when there is a large number of display components. That is, in the field 430, the scroll key 431 is displayed as scroll buttons that can be pressed when all of the display components cannot be displayed at once. The field 430 also includes a registration key 433 for registering selected display components.

In editing of the personalized screen, when display components desired by the user are selected and the registration key 433 is pressed, the selected display components are displayed in a personalized screen field 440. In the personalized screen field 440, for example, the display components are displayed starting from the upper left in the order that the display components were selected.

Next is a description of a registration screen 700 displayed after editing, with reference to FIG. 7. FIG. 7 shows an example of the registration screen 700 displayed in the display unit 204 of the image forming apparatus according to the first embodiment. The displayed screen transitions to the registration screen 700 when the registration key 433 has been pressed in the registration screen 600, and the registration screen 700 shows a provisionally determined screen when editing the personalized screen.

In the registration screen 700, a copy key 404, a scan and send key 405, a scan and save key 406, a web browser key 407, and a server document key 441 are registered in the personalized screen field 440. Also, in addition to the display configuration of the registration screen 600, the registration screen 700 includes a select and delete key 442, a term of validity setting key 443, and a setting complete key 444.

By putting a button that the user wishes to delete from the personalized screen field 440 in a selected state, and then pressing the select and delete key 442, it is possible to delete that button from the personalized screen field 440. For example, by pressing the server document key 441 to put the server document key 441 in a selected state, and then pressing the select and delete key 442, the server document key 441 is deleted from the personalized screen field 440.

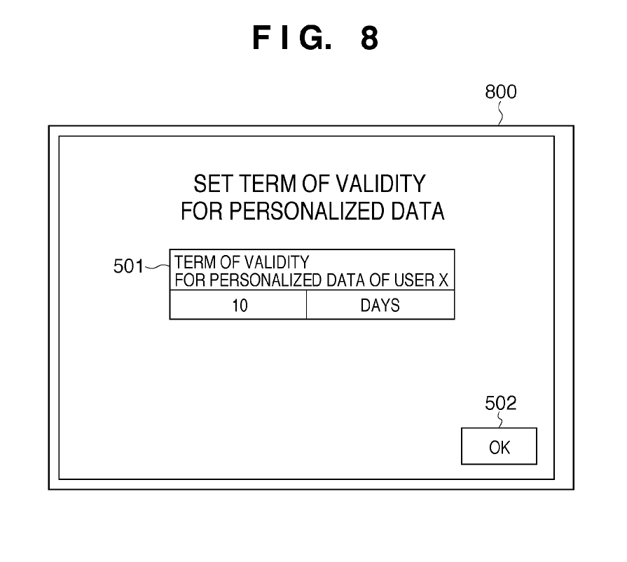

By pressing the term of validity setting key 443, it is possible to display a setting screen 800 shown in FIG. 8, and set a term of validity for the personalized data. FIG. 8 shows an example of the setting screen 800 displayed in the display unit 204 of the image forming apparatus according to the first embodiment. In the setting screen 800, for example, it is possible to set a term of validity for personalized data as shown in the setting field denoted by reference numeral 501. Also, in the setting screen 800, an example is shown in which a term of validity has been set to 10 days using a unit of days. The unit used to set the term of validity may also be weeks or months. Reference numeral 502 denotes an OK key, which is a key that fixes the term of validity setting.

Next, the description returns to FIG. 7. When the user presses the setting complete key 444, the button arrangement in the currently selected state displayed in the personalized screen field 440 is fixed. When the button arrangement is fixed, the personalized data and the term of validity setting are stored in a predetermined storage area.

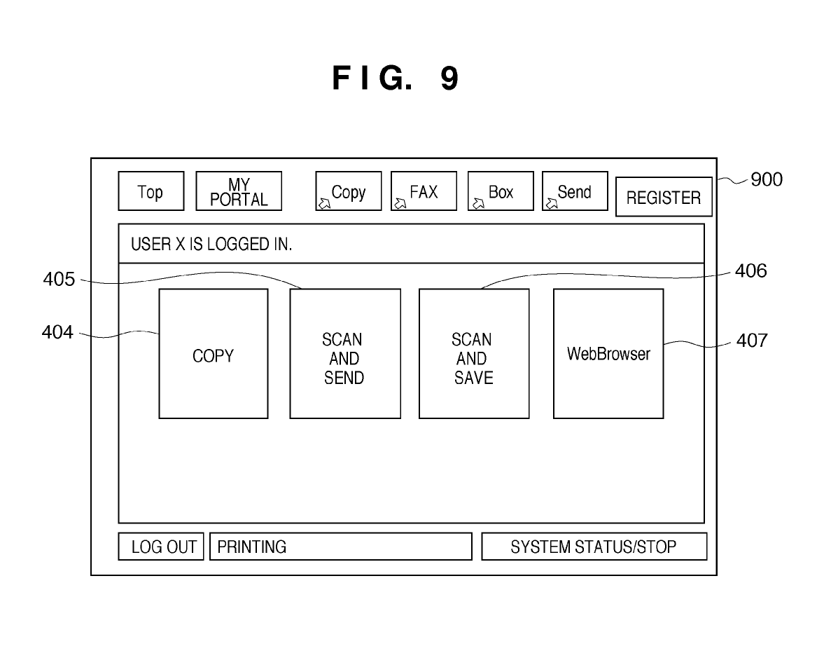

Next, a complete screen 900 in which personalized screen editing has been completed will be described with reference to FIG. 9. FIG. 9 shows an example of the complete screen 900 after editing of the personalized screen displayed in the display unit 204 of the image forming apparatus according to the first embodiment.

The complete screen 900 is displayed in the display unit 204 of the image forming apparatus when the setting complete key 444 has been pressed in the registration screen 700. The copy key 404, the scan and send key 405, the scan and save key 406, and the web browser key 407 that have been selected in the registration screen 700 are registered in the complete screen 900. The edited and registered personalized screen is displayed as a basic operation screen the next time that the corresponding user logs in.

Personalized Data

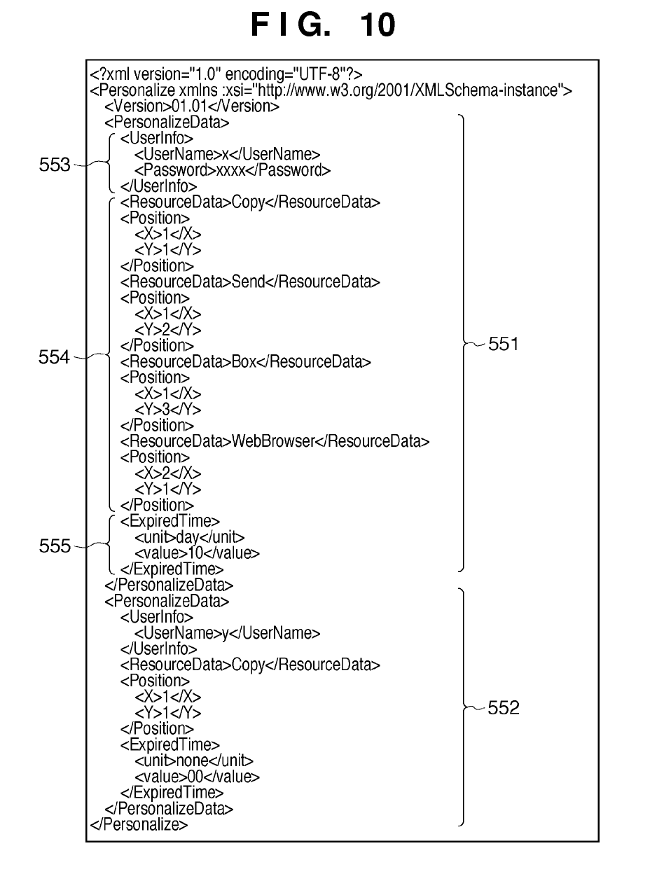

Next is a description of personalized data with reference to FIG. 10. FIG. 10 shows an example of personalized data according to a first embodiment.

As shown in FIG. 10, the personalized data is stored as an XML file, for example. Personalized data for a plurality of users can be stored in this XML file. In FIG. 10, reference numeral 551 denotes personalized data of a user X, and reference numeral 552 denotes personalized data of a user Y.

Included in the personalized data 551 is user information 553 of the user X, display unit information 554 of the user X, and term of validity information 555. The user information 553 includes information regarding a username and a password for that user. Also, the display unit information 554 includes information regarding the type and arranged position of buttons displayed in the basic operation screen. Also, the term of validity information 555 includes information regarding the term of validity of the personalized data.

Various Messages

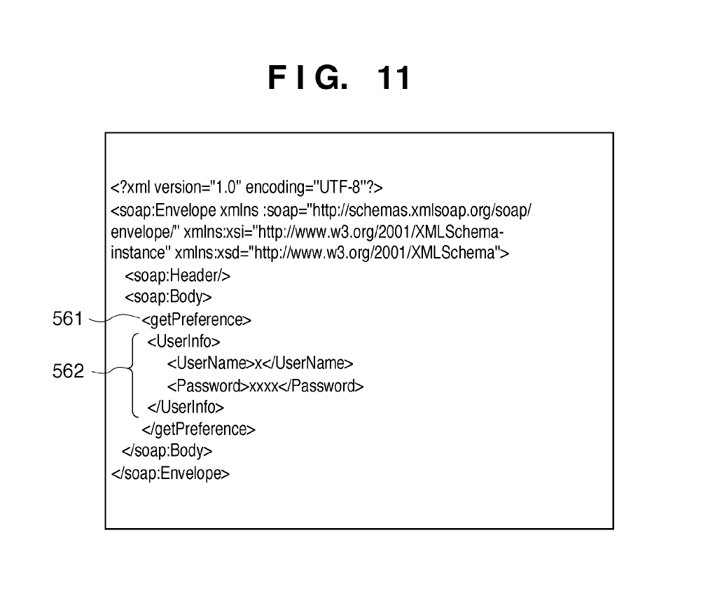

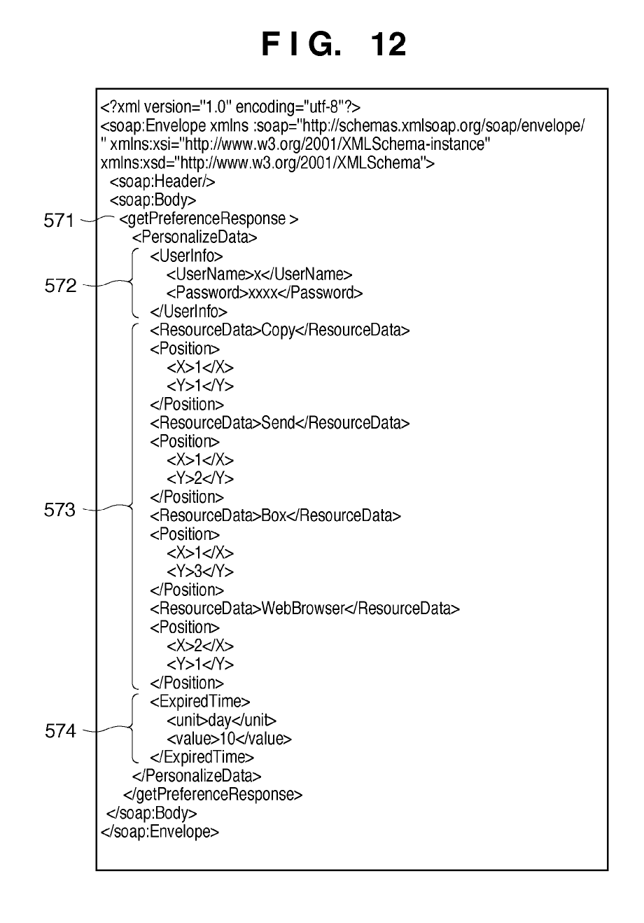

Next is a description of an acquisition request message and a message responding thereto when acquiring personalized data from another image forming apparatus, with reference to FIGS. 11 and 12. FIG. 11 shows an example of an acquisition request message according to the first embodiment.

The acquisition request message according to the present embodiment is described according to SOAP based on XML, as an example. Specifically, reference numeral 561 denotes an acquisition request API name, and reference numeral 562 denotes user information. The image forming apparatus that has received this acquisition request message reads out the personalized data corresponding to the user information 562 from the storage area of this image forming apparatus, and transmits the data to the image forming apparatus that made the request.

FIG. 12 shows an example of a response message according to the first embodiment. The response message according to the present embodiment is described according to SOAP based on XML, as an example. Specifically, reference numeral 571 denotes a response name for a response to the acquisition request message shown in FIG. 11, reference numeral 572 denotes user information, reference numeral 573 denotes personalized data, and reference numeral 574 denotes term of validity information.

Flow of Control

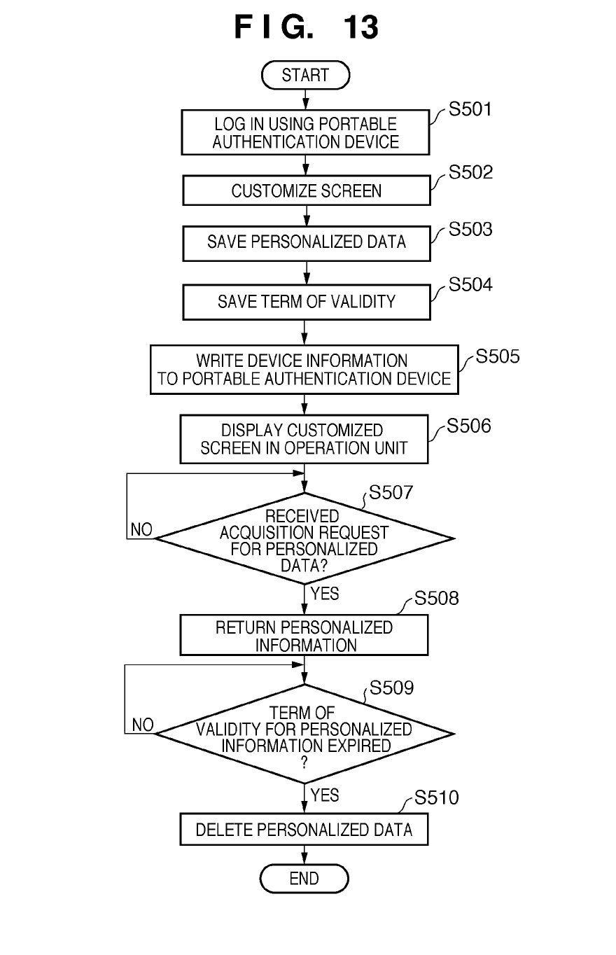

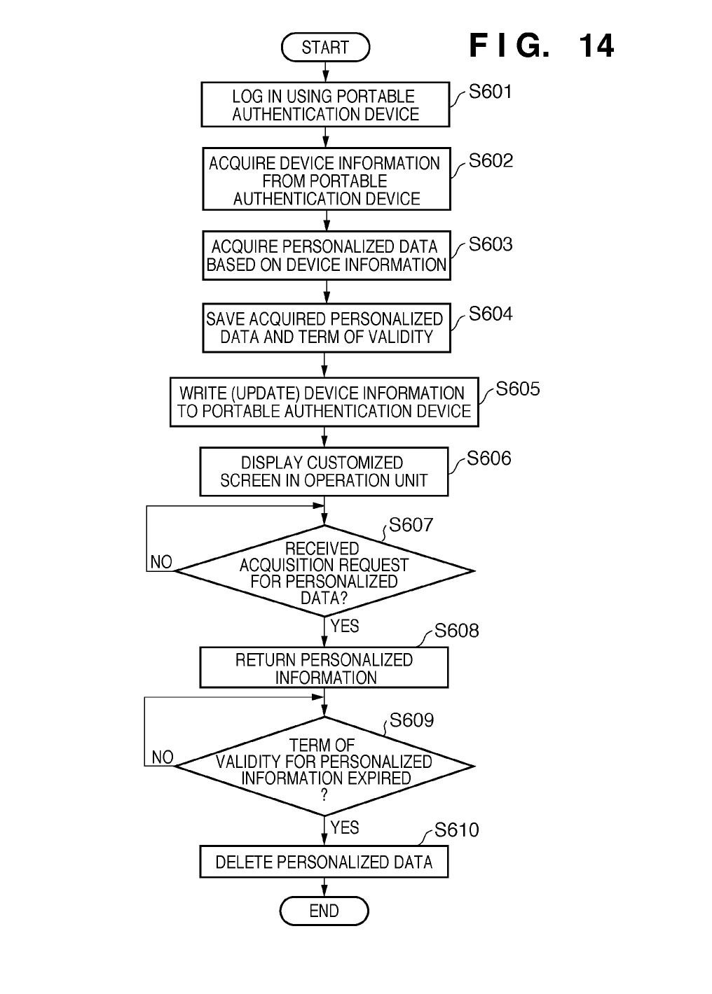

Next is a description of the flow of control to display a personalized screen in the information processing system 1000, with reference to FIGS. 13 and 14. The processing described below is centrally controlled by the control unit 205 in each image forming apparatus. FIG. 13 is a flowchart that shows the processing procedure in the image forming apparatus 100 according to the first embodiment. The flowchart in FIG. 13 shows processing when access has been performed by a user for which personalized data is being held in the storage area 101 of the image forming apparatus 100.

In Step S501, when access from a user is detected, the control unit 205 causes the display unit 204 to display the authentication screen 400. As a result, the user inserts the portable authentication device 110 at a predetermined location in the image forming apparatus 100, and logs in. Then, the control unit 205 acquires user information from the inserted portable authentication device 110, and performs authentication. Further, the control unit 205 acquires the device information shown in FIG. 3 along with the user information, and determines whether or not that device information is information that indicates this apparatus (the image forming apparatus 100). Below, processing when the device information is information that indicates this apparatus will be described.

When authentication is successful, in Step S502, the control unit 205 displays the display screens shown in FIGS. 6 to 8 in the display unit 204 according to input from the user via the display unit 204, thus allowing editing of the personalized screen to be performed.

When editing ends, in Step S503, the control unit 205 saves information regarding the edited personalized screen in the storage area. Further, in Step S504, the control unit 205 stores the term of validity information for the edited personalized screen, tied to the information regarding the personalized screen. Here, when term of validity information has not been set for the edited information, the control unit 205 may set a predetermined term of validity, or may not set term of validity information.

Next, in Step S505, the control unit 205 writes the device information of the image forming apparatus 100 to the portable authentication device 110 that has been inserted into this apparatus. The written content may be an IP address of the image forming apparatus 100 as shown in FIG. 3, or may be a host name or the like. Further, in Step S506, the control unit 205 displays the complete screen 900 shown in FIG. 9 in the display unit 204. Thus, the user can confirm the personalized screen that the user has edited.

Next, in Step S507, the control unit 205 determines whether or not an acquisition request for the personalized data saved in Step S503 has been received from another device. Here, when an acquisition request message has been received, processing proceeds to Step S508, and when an acquisition request message has not been received, the determination in Step S507 is periodically repeated. In Step S508, the control unit 205 returns the personalized data saved in Step S503 to the source of the acquisition request as a response message.

Next, in Step S509, the control unit 205 determines whether or not the term of validity for the personalized data saved in Step S503 has passed. Here, when determined that the term of validity for that personalized data has passed, processing proceeds to Step S510, and when determined that the term of validity for that personalized data has not passed, the determination in Step S509 is periodically repeated. In Step S510, the control unit 205 deletes the personalized data whose term of validity has passed from the storage area.

The flowchart described above shows one sequence of processing that includes the processing in Steps S501 to S506 to register personalized data, the processing in Steps S507 and S508 to respond with the personalized data held by the image forming apparatus, and the processing in Steps S509 and S510 to monitor the term of validity for the personalized data. However, it is not necessary for this processing to be executed as one sequence of processing; it is sufficient that the responding process and the monitoring process for the personalized data that has been registered are periodically executed after the registration process. Also, the responding process and the monitoring process corresponding to the personalized data are ended when the personalized data is deleted in the monitoring process.

FIG. 14 is a flowchart that shows the processing procedure in the image forming apparatus 102 according to the first embodiment. The flowchart in FIG. 14 shows processing when access has been performed by a user for which personalized data is not being held in the storage area 101 of the image forming apparatus 100.

In Step S601, when access from a user is detected, the control unit 205 causes the display unit 204 to display the authentication screen 400. As a result, the user inserts the portable authentication device 110 at a predetermined location in the image forming apparatus 102, and logs in. Then, the control unit 205 acquires user information from the inserted portable authentication device 110, and performs authentication.

Next, in Step S602, the control unit 205 acquires device information from the portable authentication device 110. Here, the control unit 205 confirms the acquired device information, and determines whether or not that device information is information that indicates this apparatus. Below, processing when the device information is information that does not indicate this apparatus will be described.

In Step S603, the control unit 205 transmits an acquisition request message for the personalized data shown in FIG. 11 to the device indicated by the device information. Here, an acquisition request message is transmitted to the image forming apparatus 102. Next, in Step S604, the control unit 205 receives the personalized data as the response message shown in FIG. 12, and stores the personalized data along with information regarding the term of validity of that personalized data in the storage area.

Next, in Step S605, the control unit 205 performs an update to new device information in the portable authentication device 110. Here, the device information is an IP address or host name of the image forming apparatus 102. Further, in Step S606, the control unit 205 displays a basic operation screen based on the acquired personalized data in the display unit 204.

Next, in Step S607, the control unit 205 determines whether or not an acquisition request for the personalized data saved in Step S604 has been received from another device. Here, when an acquisition request message has been received, processing proceeds to Step S608, and when an acquisition request message has not been received, the determination in Step S607 is periodically repeated. In Step S608, the control unit 205 returns the personalized data saved in Step S604 to the source of the acquisition request as a response message.

Next, in Step S609, the control unit 205 determines whether or not the term of validity for the personalized data saved in Step S604 has passed. Here, when determined that the term of validity for that personalized data has passed, processing proceeds to Step S610, and when determined that the term of validity for that personalized data has not passed, the determination in Step S609 is periodically repeated. In Step S610, the control unit 205 deletes the personalized data whose term of validity has passed from the storage area.

The flowchart described above shows one sequence of processing that includes the processing in Steps S601 to S606 to acquire personalized data, the processing in Steps S607 and S608 to respond with the personalized data held by the image forming apparatus, and the processing in Steps S609 and S610 to monitor the term of validity for the personalized data. However, it is not necessary for this processing to be executed as one sequence of processing; it is sufficient that the responding process and the monitoring process for the personalized data that has been registered are periodically executed after the registration process. Also, the responding process and the monitoring process corresponding to the personalized data are ended when the personalized data is deleted in the monitoring process.

Also, in the present embodiment, the control unit 205 performs user authentication, but a configuration may also be adopted in which the information processing system 1000 is provided with an unshown authentication server, and the image forming apparatus 100 transmits user information to the authentication server and acquires the result of authentication from the authentication server.

As described above, the information processing system according to the present embodiment is provided with a plurality of information processing apparatuses that are provided with a storage area that stores personalized data, which is unique information for each user. When a portable authentication device is connected, each information processing apparatus reads out device information that indicates which information processing apparatus is storing the user information and personalized data, performs authentication, and acquires the corresponding personalized data based on the device information. Also, personalized data is stored in the storage area at the time when the information processing apparatus is accessed by the user. A term of validity is set for the personalized data stored in the storage area, and that data is deleted when the term of validity has passed. Thus, in this information processing system, it is possible to store the personalized data in an information processing apparatus that is frequently used by the user, without requiring a server that manages personalized data. Also, because the personalized data is distributed to and stored in a plurality of information processing apparatuses, it is possible to keep the consumption of memory resources of each information processing apparatus to the minimum necessary. Furthermore, in comparison to a system in which a server is provided, when an information processing apparatus that has been accessed by a user holds the personalized data, it is possible to acquire personalized data without communicating with another information processing apparatus, and so it is possible to reduce the processing load and the network load.

The present invention is not limited by the above embodiment; various modifications are possible. For example, when the device information stored in the portable authentication device indicates another information processing apparatus, the information processing apparatus to which the portable authentication device is connected may store personalized data in the storage area of the information processing apparatus to which the portable authentication device is connected and update the device information in the portable authentication device to the device information of the information processing apparatus to which the portable authentication device is connected. Thus, in this information processing system, it is possible to hold personalized data in the information processing apparatus most recently used by the user, and therefore there is a high likelihood that the information processing apparatus is holding the personalized data of that user the next time that information processing apparatus is used, so personalized data can be acquired more efficiently.

Also, in the above embodiment, processing that displays a basic operation screen in a display unit is described as an example of processing employing personalized data. However, the present invention is not limited to such processing, and is compatible with any sort of processing that is unique to a particular user.

### Second Embodiment

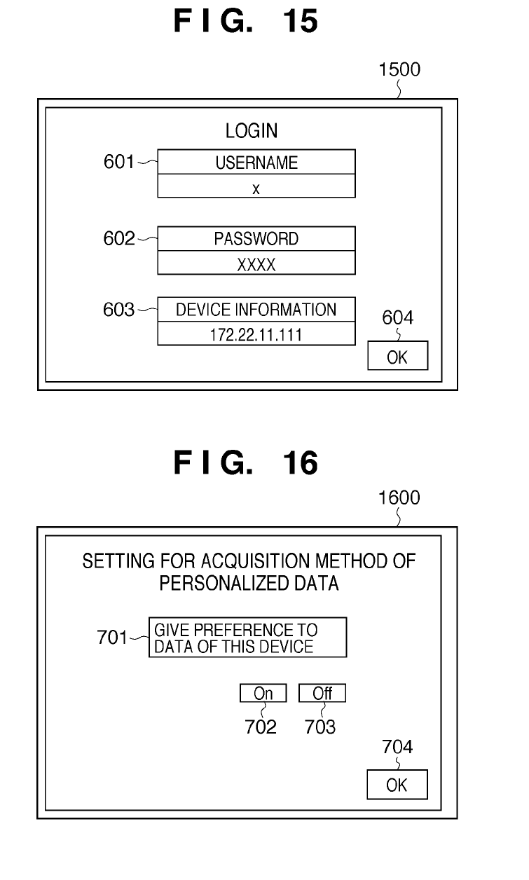

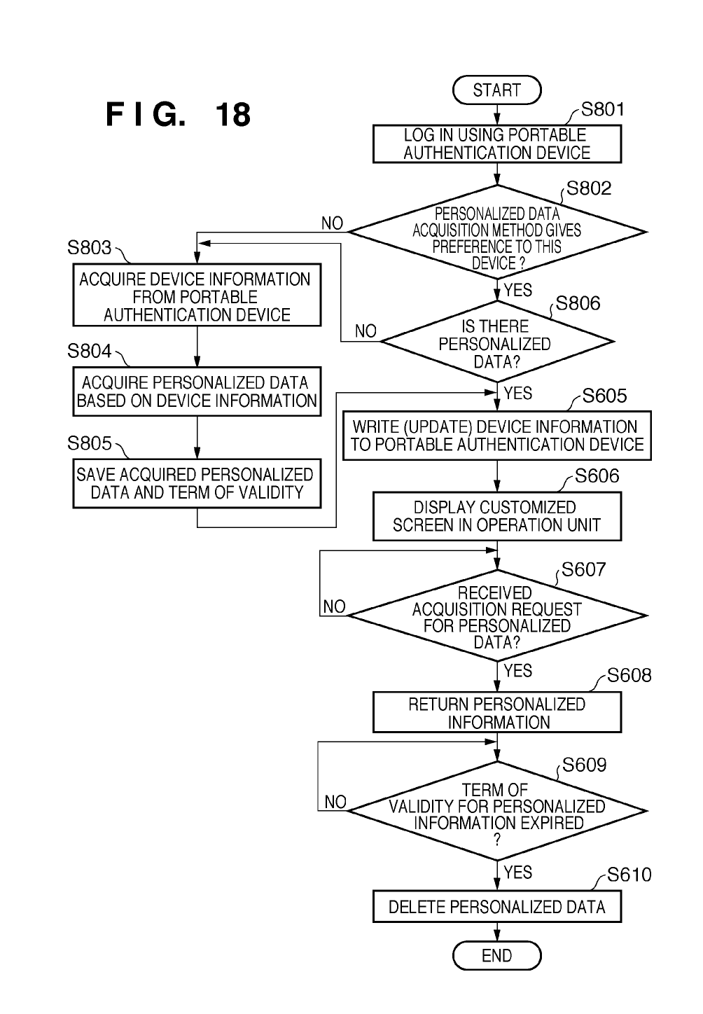

Next is a description of a second embodiment with reference to FIGS. 15 and 17. The present embodiment differs from the first embodiment with respect to the authentication portion. Specifically, in the present embodiment, instead of using the portable authentication device 110 in the first embodiment, the user manually inputs authentication information. Below, only the processing that differs from the first embodiment will be described.

FIG. 15 shows an example of an input screen 1500 displayed in the display unit 204 of the image forming apparatus according to the second embodiment. As shown in FIG. 15, the input screen 1500 includes a username input field 601, a password input field 602, a device information input field 603, and an OK key 604. These pieces of information are manually input using a hard keyboard or a soft keyboard. Accordingly, an image forming apparatus that has been accessed recognizes where personalized data will be acquired based on the device information that has been input by the user.

FIG. 17 is a flowchart that shows the processing procedure in the image forming apparatus 102 according to the second embodiment. The flowchart in FIG. 17, like the flowchart in FIG. 14, shows processing when access has been performed by a user for which personalized data is not being held in the storage area 101 of the image forming apparatus 100. Accordingly, the same processing as in FIG. 14 has the same step number, and a description thereof is omitted here. That is, below only the processing of Step S701 will be described.

In the case of authentication by manual input, in Step S701, when access from the user is detected, the control unit 205 causes the display unit 204 to display the input screen 1500. Here, the control unit 205 uses the user information and password entered via the input screen 1500 to execute authentication processing. Also, the control unit 205 acquires device information input via the input screen 1500. Accordingly, the processing in Step S701 corresponds to the processing in Steps S601 and S602 shown in FIG. 14.

When device information is acquired, the processing in Steps S603 to S606 shown in FIG. 14 is executed. However, in the present embodiment, the portable authentication device 110 is not used, so the processing in Step S605 is not performed. When the processing in Steps S603 to S606 ends, as in the first embodiment, the responding process and the monitoring process in Steps S607 to S610 are executed.

As described above, in the information processing system according to the present embodiment, unlike the first embodiment, input of user information and device information is allowed when a portable authentication device is not used. Thus, even though input for user authentication is performed manually, by allowing input of user information and also device information when performing authentication, the same effects as in the first embodiment can be realized.

### Third Embodiment

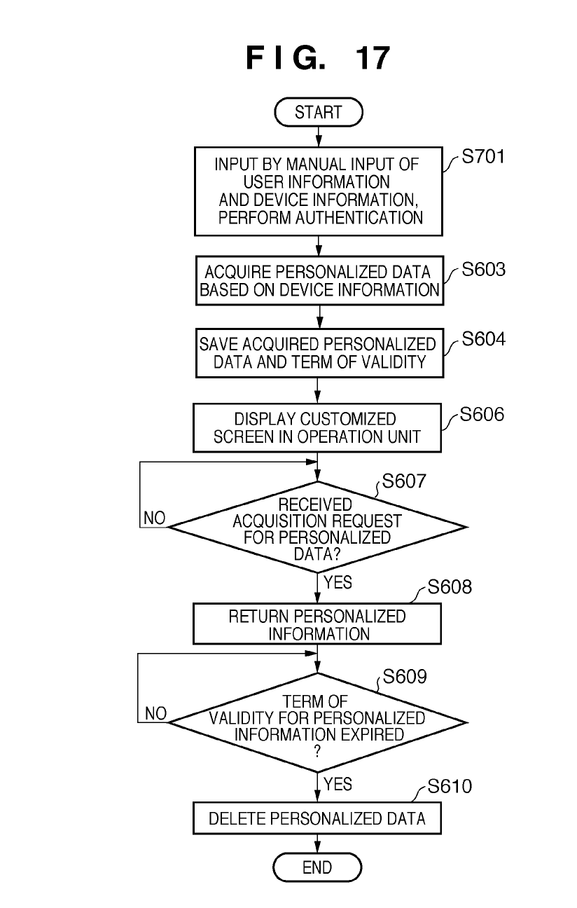

Next is a description of a third embodiment with reference to FIGS. 16 and 18. The present embodiment differs from the above embodiments in that when acquiring personalized data, if there is personalized data of the corresponding user in this apparatus, a basic operation screen is generated by preferentially using that data. Below, only the processing that differs from the above embodiments will be described.

First, a selection screen for selecting a method for acquiring personalized data in the present embodiment will be described with reference to FIG. 16. FIG. 16 shows an example of a selection screen 1600 according the third embodiment.

The selection screen 1600 includes a display field 701, an On key 702, an Off key 703, and an OK key 704. In the display field 701 there is a display for allowing the user to select whether or not to perform selection by giving preference to data being held in this device (image forming apparatus). When the OK key 704 is pressed with the On key 702 selected, the image forming apparatus preferentially uses the personalized data being held in this image forming apparatus. That is, even if device information of another apparatus has been stored in the portable authentication device 110, preference is given to acquisition of personalized data of this user that is stored in the RAM 208 or the HDD 209 of this apparatus. On the other hand, when the OK key 704 is pressed with the Off key 703 selected, the image forming apparatus acquires personalized data based on the device information stored in the portable authentication device 110, same as in the first embodiment.

FIG. 18 is a flowchart that shows the processing procedure in the image forming apparatus 102 according to the third embodiment. The same processing as in FIG. 14 has the same step number, and a description thereof is omitted here. That is, below only the processing of Steps S801 to S805 will be described.

In Step S801, when access from the user is detected, the control unit 205 causes the display unit 204 to display the authentication screen 400. As a result, the user inserts the portable authentication device 110 at a predetermined location in the image forming apparatus 102, and logs in. Then, the control unit 205 acquires user information from the inserted portable authentication device 110, and performs authentication. When authentication is successful, the control unit 205 further displays the selection screen 1600 in the display unit 204, and causes the user to select where personalized data will be acquired.

In Step S802, the control unit 205 determines whether or not the information that has been selected via the selection screen 1600 is information for which this apparatus is to be given priority. Here, when this is not information for which this apparatus is to be given priority, processing proceeds to Step S803, and when this is information for which this apparatus is to be given priority, processing proceeds to Step S806.

In Step S803, the control unit 205 acquires device information from the portable authentication device 110, and in Step S804, the control unit 205 acquires personalized data from that device. Furthermore, in Step S805, the control unit 205 stores the acquired personalized data and term of validity information in the storage area, and then moves processing to Step S807.

On the other hand, when a determination has been made in Step S802 that preference is given to information of this apparatus, in Step S806, the control unit 205 determines whether or not personalized data of this user is stored in the storage area of this apparatus. Specifically, the control unit 205 searches for information in the storage area using user information as a search keyword. Here, when personalized data for this user is being held, regardless of the device information, the personalized data of this apparatus is acquired from the storage area and processing proceeds to Step S605. On the other hand, when personalized data for this user is not being held, processing proceeds to Step S803, and the processing of above steps 5803 to S805 is executed. The processing of Steps S605 to S610 is the same as in the first embodiment, so a description thereof is omitted here.

As described above, in the information processing system according to the present embodiment, unlike in the first embodiment, regardless of the device information, when this apparatus is holding personalized data of this user, data of this apparatus is preferentially acquired. Thus, this information processing system is able to more efficiently acquire personalized data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-035810 filed on Feb. 18, 2009, which is hereby incorporated by reference herein in its entirety.

1. An information processing apparatus that is provided with a storage unit that stores personalized data, which is unique setting information for each user regarding processing executed by the information processing apparatus, and is connected to at least one other information processing apparatus via a network, the information processing apparatus comprising:
a read-out unit that, when a portable authentication device storing user information for authenticating a user and device information has been connected to said information processing apparatus, reads out the user information and the device information, wherein the device information indicates which information processing apparatus among a plurality of information processing apparatuses connected via the network is storing personalized data corresponding to the user indicated by the user information;
an authentication unit that performs processing related to authentication of the user using the user information;
an acquisition unit that, when authentication by the processing related to authentication of the user by the authentication unit has been successful, (i) acquires the personalized data corresponding to the user indicated by the user information from another information processing apparatus via the network, in a case where the device information indicates another information processing apparatus, and (i) acquires the personalized data corresponding to the user indicated by the user information from the storage unit, in a case where the device information indicates said information processing apparatus to which the portable authentication device is connected; and
an execution unit that executes user-unique processing based on the acquired personalized data.

2. The information processing apparatus according to claim 1, further comprising an updating unit that, in a case where the device information stored in the portable authentication device indicates another information processing apparatus, stores the personalized data acquired from the other information processing apparatus in the storage unit, and updates the device information of the portable authentication device to indicate said information processing apparatus.

3. The information processing apparatus according to claim 2, wherein the updating unit comprises:
a setting unit that, when said information processing apparatus has been accessed by a user for which the personalized data is not stored in the storage unit, displays in a display unit of said information processing apparatus a setting screen for setting term of validity information that indicates a term of validity for the personalized data, to allow the user to set the term of validity; and
a deletion unit that deletes the personalized data stored in the storage unit when the term of validity has passed.

4. The information processing apparatus according to claim 1, further comprising:
a registration unit that, when the device information is not stored in the portable authentication device, displays in a display unit of said information processing apparatus a registration screen for registering the personalized data, to allow the user to perform registration; and
a write unit that, when the personalized data is registered, writes the device information of said information processing apparatus to the portable authentication device.

5. The information processing apparatus according to claim 1, wherein the personalized data is information that indicates the configuration of a display screen displayed in a display unit of said information processing apparatus, and
the execution unit displays a user-unique display screen in the display unit of said information processing apparatus based on the personalized data.

6. The information processing apparatus according to claim 1, wherein even when the device information indicates another information processing apparatus, when the personalized data corresponding to the user indicated by the user information is stored in the storage unit, the acquisition unit acquires the personalized data corresponding to the user indicated by the user information from the storage unit.

7. The information processing apparatus according to claim 1, wherein the authentication unit comprises a unit that, when said information processing apparatus has been accessed by a user without the portable authentication device being connected, causes a display unit of the information processing apparatus to display an input screen for allowing the user to input the user information and the device information.

8. A method for controlling an information processing apparatus that is provided with a storage unit that stores personalized data, which is unique setting information for each user regarding processing executed by the information processing apparatus, and is connected to at least one other information processing apparatus via a network, the method comprising:
reading out, when a portable authentication device storing user information for authenticating a user and device information has been connected to the information processing apparatus, the user information and the device information, wherein the device information indicates which information processing apparatus among a plurality of information processing apparatuses connected via the network is storing personalized data corresponding to the user indicated by the user information;
performing processing related to authentication of the user using the user information;
acquiring, when the authentication has been successful, the personalized data corresponding to the user indicated by the user information (i) from another information processing apparatus via the network, in a case where the device information indicates another information processing apparatus, and (ii) from the storage unit, in a case where the device information indicates the information processing apparatus to which the portable authentication device is connected; and
executing user-unique processing based on the acquired personalized data.

9. A computer-readable storage medium storing a computer program that causes a computer to execute the control method according to claim 8.
